(19) United States
(12) Patent Application Publication
(10) Pub. No.: US 2005/0206482 A1
(43) Pub. Date: Sep. 22, 2005

(54) Electronically tunable switched-resonator filter bank

(76) Inventors: Nicolaas DuToit, Columbia, MD (US); Qinghua Kang, Newark, DE (US)

Correspondence Address: William J. Tucker, 14431 Goliad Dr., Box #8, Malakoff, TX, 75148, US

(21) Appl. No.: 10/880,125

(22) Filed: Jun. 29, 2004

Related U.S. Application Data
(60) Provisional application No. 60/553,997, filed on Mar. 17, 2004.

(51) Int. Cl. H01P 1/203

(52) U.S. Cl. 333/205

(57) ABSTRACT

A voltage-controlled tunable suspended stripline planar filter, comprising a first resonator, the first resonator including at least one tunable capacitor and at least one PIN diode, and a second resonator coupled to the first resonator, the second resonator including at least one tunable capacitor and at least one PIN diode. The tunable filter may further comprising a low-pass section between a coupling line coupling said first and said second resonator and an input port and the first resonator may be coupled to the second resonator through proximity coupling. Further, in one embodiment of the present invention the at least one PIN diode in the first resonator may be two PIN diodes and the at least one tunable capacitor in the first resonator may be two tunable capacitors.

### CROSS-REFERENCE TO RELATED APPLICATION

This application claims priority to U.S. Provisional Patent Application Ser. No. 60/500,564, “Electronically Tunable Switched-Resonator Filter Bank” filed Mar. 17, 2004, by DuToit et al.

### BACKGROUND OF THE INVENTION

Electrically tunable microwave filters have found a wide range of applications in microwave systems. Compared to mechanically and magnetically tunable filters, electronically tunable filters have a very important advantage of having a fast tuning capability over wide frequency band applications. Because of this advantage, they can be used in the applications such as LMDS (local multipoint distribution service), cellular, PCS (personal communication system), frequency hopping, satellite communication, and radar systems. In the electronically tunable filters, filters can be divided into two types: 1) voltage-controlled tunable dielectric capacitor based tunable filters; and 2) semiconductor varactor based tunable filters. Compared to semiconductor varactor based tunable filters, tunable dielectric capacitor based tunable filters have the merits of lower loss, higher power-handling, and higher IP3, especially at higher frequencies (>10 GHz).

Tunable filters have been developed by Paratek Microwave, Inc., the assignee of the present invention, for microwave radio applications. Tunable filters offer service providers flexibility and scalability never before accessible. A single tunable filter solution enables radio manufacturers to replace several fixed filters needed to cover a given frequency band. This versatility provides front end RF tunability in real time applications and decreases deployment and maintenance costs through software control and reduced component count. Also, fixed filters need to be wide band so that their count does not exceed reasonable numbers to cover the desired frequency plan. Tunable filters, however, are narrow band, and can cover even larger frequency bands than fixed filters by tuning the filters over a wide range. Additionally, narrowband filters at the front end are appreciated from the systems point of view, because they provide better selectivity and help reduce interference from nearby transmitters.

Inherent in every tunable filter is the ability to rapidly tune the response using high-impedance control lines. Parascan®, the trademarked name for tunable materials technology developed by the assignee of the present invention, enables these tuning properties, as well as, high Q values, low losses and extremely high IP3 characteristics, even at high frequencies. MEMS based varactors can also be used for this purpose. They use different bias voltages to vary the electrostatic force between two parallel plates of the varactor and hence change its capacitance value. They show lower Q than dielectric varactors, and have worse power handling, but can be used successfully for some applications. Also, diode varactors could be used to make tunable filters, although with worse performance and poorer power handling capability than dielectric varactors.

However, even though the aforementioned tunable filter technology has excellent performance, there is an ongoing need for an even wider range of frequency selection in complex radio systems.

### SUMMARY OF THE INVENTION

One embodiment of the present invention provides a voltage-controlled tunable suspended stripline planar filter, comprising a first resonator, the first resonator including at least one tunable capacitor and at least one PIN diode, and a second resonator coupled to the first resonator, the second resonator including at least one tunable capacitor and at least one PIN diode. The tunable filter may further comprise a low-pass section between a coupling line coupling said first and said second resonator and an input port and the first resonator may be coupled to the second resonator through proximity coupling. Further, in one embodiment of the present invention the at least one PIN diode in the first resonator may be two PIN diodes and the at least one tunable capacitor in the first resonator may be two tunable capacitors. Additionally, the at least one PIN diode in the second resonator may be two PIN diodes and the at least one tunable capacitor in the second resonator may be two tunable capacitors.

The tunable filter may further comprise at least one DC blocking capacitor in the first resonator and at least one DC blocking in the second resonator; and in one embodiment of the present invention, the at least one DC blocking capacitor in the first resonator may be two DC blocking capacitors and the at least one DC blocking in the second resonator may be two DC blocking capacitor. The tunable filter in one embodiment may further comprise an input transmission line coupled to the first resonator and an output transmission line coupled to the second resonator. Further, in one embodiment the tunable filter may further comprise an input transmission line coupled to the first resonator and at least one DC biasing line associated with the at least one tunable capacitor included within the first resonator, and at least one DC biasing line associated with the at least one tunable capacitor included within the second resonator. An embodiment of the present invention may further comprise at least one resister in the at least one DC biasing line associated with the at least one tunable capacitor included within the first resonator; or at least one resister in the at least one DC biasing line associated with the at least one tunable capacitor included within the second resonator; and the low-pass section may comprise a series inductor between two shunt capacitors forming a “π” section.

The at least one tunable capacitor included within the first resonator in one embodiment may be a tunable dielectric capacitor and/or the at least one tunable capacitor included within the second resonator may be a tunable dielectric. Further, the at least one tunable dielectric capacitor included within the first resonator may comprise a low loss tunable dielectric material and may have metallic electrodes with predetermined shape, size, and distance; and/or the at least one tunable dielectric capacitor included within the second resonator may comprise a low loss tunable dielectric material and may have metallic electrodes with predetermined shape, size, and distance. In another embodiment, at least one additional resonator is included and the at least one additional resonator may be coupled to the first or the second resonator.

In another embodiment of the present invention the at least one tunable capacitor included within the first or the second resonator is at least one MEM tunable capacitors and the at least one MEM tunable capacitor may utilize a parallel plate topology or an interdigital topology. In yet another embodiment, the at least one tunable capacitor included within the first or the second resonator may be at least one semiconductor tunable capacitor.

The tunable filter's center frequency may be tuned by changing the capacitance of the tunable capacitor by changing the bias voltage and the center frequency of the filter may be step-changed by switching the at least one PIN diode to vary the resonator length.

In still another embodiment the invention provides a method of tuning a filter by applying a voltage, comprising varying the capacitance of a tunable capacitor by applying a voltage, the tunable capacitor included in a first resonator, the first resonator further including at least one PIN diode; and varying the capacitance of a tunable capacitor by applying a voltage, the tunable capacitor included in a second resonator, the second resonator further including at least one PIN diode and is coupled to the first resonator. The method may further comprise step-changing the center frequency of the filter by switching the PIN diodes to vary the resonator length of the first and/or the second resonators and coupling a low-pass section between a coupling line coupling the first and the second resonator and an input port. The coupling may be through proximity coupling.

### BRIEF DESCRIPTION OF THE DRAWINGS

FIG. 1 is a block diagram illustrating a tunable filter of the tunable filter bank of one embodiment of the present invention;

FIG. 2. illustrates the assembly of a two-pole switched-resonator filter bank according to one embodiment of the present invention;

FIG. 3. illustrates a more detailed planar structure of the two-pole switched-resonator filter bank of one embodiment of the present invention;

FIG. 4. is a circuit diagram illustrating the equivalent circuit of the two-pole switched-resonator filter bank of one embodiment of the present invention;

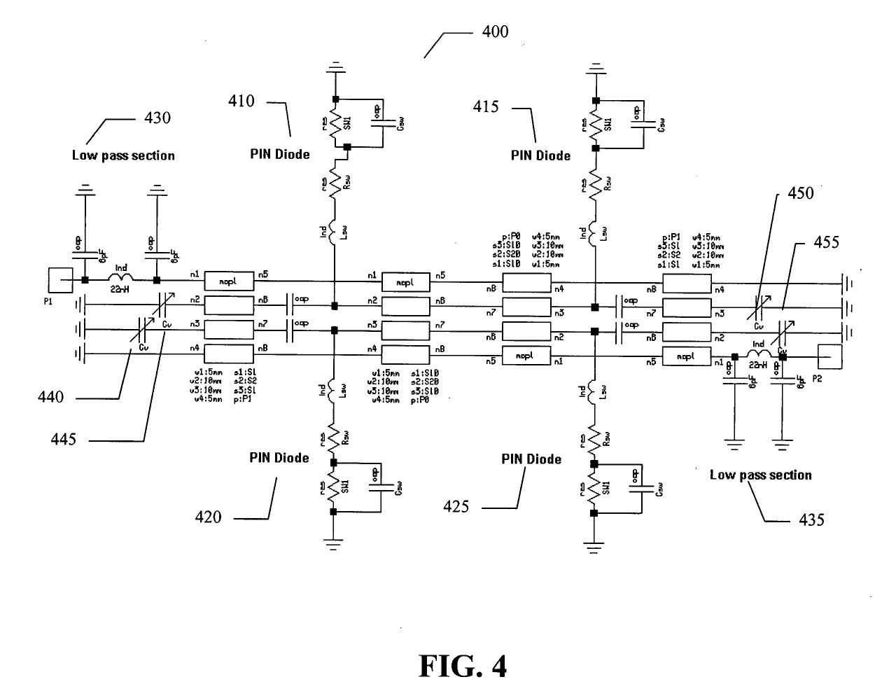

FIG. 5. is a diagram showing the filter response with PIN diodes switched OFF and varactors zero bias;

FIG. 6. is a diagram showing the filter response with PIN diodes switched OFF and varactors high bias;

FIG. 7. is a diagram showing the filter response with PIN diodes switched ON and varactors zero bias; and

FIG. 8. is a diagram showing the filter response with PIN diodes switched ON and varactors high bias.

### DESCRIPTION OF THE PREFERRED EMBODIMENT

It is an objective of the present invention to provide a voltage-tuned filter having low insertion loss, fast tuning speed, high power-handling capability, high IP3 and low cost in the radio frequency range. Compared to MEMS varactors or voltage-controlled semiconductor varactors, voltage-controlled tunable capacitors have higher Q factors, higher power-handling and higher IP3. The voltage-controlled tunable dielectric capacitors of the present invention may be employed in the filter structure of the present invention.

The tunable dielectric capacitor in the present invention may be made from low loss tunable dielectric material. The range of Q factor of the tunable dielectric capacitor may be between 50, for very high tuning material, and 300 or higher, for low tuning material. It also decreases with increasing the frequency, but even at higher frequencies say 30 GHz may take values as high as 100. A wide range of capacitance of the tunable dielectric capacitors may be available, from several pF to several μF. The tunable dielectric capacitor may be a two-port component, in which the tunable dielectric material may be sandwiched between two specially shaped parallel electrodes. An applied voltage produces an electric field across the tunable dielectric, which produces an overall change in the capacitance of the tunable dielectric capacitor.

As mentioned above, Parascan® as used herein is a trademarked word indicating the aforementioned tunable dielectric material developed by the assignee of the present invention. Parascan® tunable dielectric materials have been described in several patents. Barium strontium titanate (BaTiO3-SrTiO3), also referred to as BSTO, may be, although is not limited to being, used for its high dielectric constant (200-6,000) and large change in dielectric constant with applied voltage (25-75 percent with a field of 2 Volts/micron). Tunable dielectric materials including barium strontium titanate are disclosed in U.S. Pat. No. 5,312,790 to Sengupta, et al. entitled “Ceramic Ferroelectric Material”; U.S. Pat. No. 5,427,988 by Sengupta, et al. entitled “Ceramic Ferroelectric Composite Material-BSTO-MgO”; U.S. Pat. No. 5,486,491 to Sengupta, et al. entitled “Ceramic Ferroelectric Composite Material—BSTO-ZrO2”; U.S. Pat. No. 5,635,434 by Sengupta, et al. entitled “Ceramic Ferroelectric Composite Material-BSTO-Magnesium Based Compound”; U.S. Pat. No. 5,830,591 by Sengupta, et al. entitled “Multilayered Ferroelectric Composite Waveguides”; U.S. Pat. No. 5,846,893 by Sengupta, et al. entitled “Thin Film Ferroelectric Composites and Method of Making”; U.S. Pat. No. 5,766,697 by Sengupta, et al. entitled “Method of Making Thin Film Composites”; U.S. Pat. No. 5,693,429 by Sengupta, et al. entitled “Electronically Graded Multilayer Ferroelectric Composites”; U.S. Pat. No. 5,635,433 by Sengupta entitled “Ceramic Ferroelectric Composite Material BSTO-ZnO”; U.S. Pat. No. 6,074,971 by Chiu et al. entitled “Ceramic Ferroelectric Composite Materials with Enhanced Electronic Properties BSTO Mg Based Compound-Rare Earth Oxide”. These patents are incorporated herein by reference. The materials described in these patents, especially BSTO-MgO composites, may show low dielectric loss and high tunability. Tunability is defined as the fractional change in the dielectric constant with applied voltage.

Barium strontium titanate of the formula BaxSr1−xTiO3 is a preferred electronically tunable dielectric material due to its favorable tuning characteristics, low Curie temperatures and low microwave loss properties. In the formula BaxSr1−xTiO3, x can be any value from 0 to 1, preferably from about 0.15 to about 0.6. More preferably, x is from 0.3 to 0.6.

Other electronically tunable dielectric materials may be used partially or entirely in place of barium strontium titanate. An example is BaxCa1−xTiO3, where x is in a range from about 0.2 to about 0.8, preferably from about 0.4 to about 0.6. Additional electronically tunable ferroelectrics include PbxZr1−xTiO3 (PZT) where x ranges from about 0.0 to about 1.0, PbxZr1−xSrTiO3 where x ranges from about 0.05 to about 0.4, KTaxNb1−xO3 where x ranges from about 0.0 to about 1.0, lead lanthanum zirconium titanate (PLZT), PbTiO3, BaCaZrTiO3, NaNO3, KNbO3, LiNbO3, LiTaO3, PbNb2O6, PbTa2O6, KSr(NbO3) and NaBa2(NbO3)5KH2PO4, and mixtures and compositions thereof. Also, these materials can be combined with low loss dielectric materials, such as magnesium oxide (MgO), aluminum oxide (Al2O3), and zirconium oxide (ZrO2), and/or with additional doping elements, such as manganese (MN), iron (Fe), and tungsten (W), or with other alkali earth metal oxides (i.e. calcium oxide, etc.), transition metal oxides, silicates, niobates, tantalates, aluminates, zirconnates, and titanates to further reduce the dielectric loss.

In addition, the following U.S. patent applications, assigned to the assignee of this application, disclose additional examples of tunable dielectric materials: U.S. application Ser. No. 09/594,837 filed Jun. 15, 2000, entitled “Electronically Tunable Ceramic Materials Including Tunable Dielectric and Metal Silicate Phases”; U.S. application Ser. No. 09/768,690 filed Jan. 24, 2001, entitled “Electronically Tunable, Low-Loss Ceramic Materials Including a Tunable Dielectric Phase and Multiple Metal Oxide Phases”; U.S. application Ser. No. 09/882,605 filed Jun. 15, 2001, entitled “Electronically Tunable Dielectric Composite Thick Films And Methods Of Making Same”; U.S. application Ser. No. 09/834,327 filed Apr. 13, 2001, entitled “Strain-Relieved Tunable Dielectric Thin Films”; and U.S. Provisional Application Ser. No. 60/295,046 filed Jun. 1, 2001 entitled “Tunable Dielectric Compositions Including Low Loss Glass Frits”. These patent applications are incorporated herein by reference.

The tunable dielectric materials can also be combined with one or more non-tunable dielectric materials. The non-tunable phase(s) may include MgO, MgAl2O4, MgTiO3, Mg2SiO4, CaSiO3, MgSrZrTiO6, CaTiO3, Al2O3, SiO2 and/or other metal silicates such as BaSiO3 and SrSiO3. The non-tunable dielectric phases may be any combination of the above, e.g., MgO combined with MgTiO3, MgO combined with MgSrZrTiO6, MgO combined with Mg2SiO4, MgO combined with Mg2SiO4, Mg2SiO4 combined with CaTiO3 and the like.

Additional minor additives in amounts of from about 0.1 to about 5 weight percent can be added to the composites to additionally improve the electronic properties of the films. These minor additives include oxides such as zirconnates, titannates, rare earths, niobates and tantalates. For example, the minor additives may include CaZrO3, BaZrO3, SrZrO3, BaSnO3, CaSnO3, MgSnO3, Bi2O3/2SnO2, Nd2O3, Pr7O11, Yb2O3, Ho2O3, La2O3, MgNb2O6, SrNb2O6, BaNb2O6, MgTa2O6, BaTa2O6 and Ta2O3.

Thick films of tunable dielectric composites may comprise Ba1−xSrxTiO3, where x is from 0.3 to 0.7 in combination with at least one non-tunable dielectric phase selected from MgO, MgTiO3, MgZrO3, MgSrZrTiO6, Mg2SiO4, CaSiO3, MgAl2O4, CaTiO3, Al2O3, SiO2, BaSiO3 and SrSiO3. These compositions may be BSTO and one of these components, or two or more of these components in quantities from 0.25 weight percent to 80 weight percent with BSTO weight ratios of 99.75 weight percent to 20 weight percent.

The electronically tunable materials may also include at least one metal silicate phase. The metal silicates may include metals from Group 2A of the Periodic Table, i.e., Be, Mg, Ca, Sr, Ba and Ra, preferably Mg, Ca, Sr and Ba. Preferred metal silicates include Mg2SiO4, CaSiO3, BaSiO3 and SrSiO3. In addition to Group 2A metals, the present metal silicates may include metals from Group 1A, i.e., Li, Na, K, Rb, Cs and Fr, preferably Li, Na and K. For example, such metal silicates may include sodium silicates such as Na2SiO3 and NaSiO3-5H2O, and lithium-containing silicates such as LiAlSiO4, Li2SiO3 and Li4SiO4. Metals from Groups 3A, 4A and some transition metals of the Periodic Table may also be suitable constituents of the metal silicate phase. Additional metal silicates may include Al2Si2O7, ZrSiO4, KalSi3O8, NaAlSi3O8, CaAl2Si2O8, CaMgSi2O6, BaTiSi3O9 and Zn2SiO4. The above tunable materials may be tuned at room temperature by controlling an electric field that may be applied across the materials.

In addition to the electronically tunable dielectric phase, the electronically tunable materials can include at least two additional metal oxide phases. The additional metal oxides may include metals from Group 2A of the Periodic Table, i.e., Mg, Ca, Sr, Ba, Be and Ra, preferably Mg, Ca, Sr and Ba. The additional metal oxides may also include metals from Group 1A, i.e., Li, Na, K, Rb, Cs and Fr, preferably Li, Na and K. Metals from other Groups of the Periodic Table may also be suitable constituents of the metal oxide phases. For example, refractory metals such as Ti, V, Cr, Mn, Zr, Nb, Mo, Hf, Ta and W may be used. Furthermore, metals such as Al, Si, Sn, Pb and Bi may be used. In addition, the metal oxide phases may comprise rare earth metals such as Sc, Y, La, Ce, Pr, Nd and the like.

The additional metal oxides may include, for example, zirconnates, silicates, titanates, aluminates, stannates, niobates, tantalates and rare earth oxides. Preferred additional metal oxides include Mg2SiO4, MgO, CaTiO3, MgZrSrTiO6, MgTiO3, MgAl2O4, WO3, SnTiO4, ZrTiO4, CaSiO3, CaSnO3, CaWO4, CaZrO3, MgTa2O6, MgZrO3, MnO2, PbO, Bi2O3 and La2O3. Particularly preferred additional metal oxides include Mg2SiO4, MgO, CaTiO3, MgZrSrTiO6, MgTiO3, MgAl2O4, MgTa2O6 and MgZrO3.

The additional metal oxide phases may be typically present in total amounts of from about 1 to about 80 weight percent of the material, preferably from about 3 to about 65 weight percent, and more preferably from about 5 to about 60 weight percent. In one preferred embodiment, the additional metal oxides comprise from about 10 to about 50 total weight percent of the material. The individual amount of each additional metal oxide may be adjusted to provide the desired properties. Where two additional metal oxides are used, their weight ratios may vary, for example, from about 1:100 to about 100:1, typically from about 1:10 to about 10:1 or from about 1:5 to about 5:1. Although metal oxides in total amounts of from 1 to 80 weight percent are typically used, smaller additive amounts of from 0.01 to 1 weight percent may be used for some applications.

The additional metal oxide phases can include at least two Mg-containing compounds. In addition to the multiple Mg-containing compounds, the material may optionally include Mg-free compounds, for example, oxides of metals selected from Si, Ca, Zr, Ti, Al and/or rare earths.

The tunable capacitors with microelectromechanical system (MEMS) technology may also be used in the tunable filter and are part of this invention. At least two varactor topologies can be used, parallel plate and interdigital. In parallel plate structure, one of the plates is suspended at a distance from the other plate by suspension springs. This distance may vary in response to electrostatic force between two parallel plates induced by applied bias voltage. In the interdigital configuration, the effective area of the capacitor may be varied by moving the fingers comprising the capacitor in and out and changing its capacitance value. MEMS varactors have lower Q than their dielectric counterpart, especially at higher frequencies, and have worse power handling, but can be used in certain applications.

An embodiment of the present invention provides a tunable filter bank made in PCB-based planar suspended stripline structure. The tuning elements may be voltage-controlled tunable dielectric capacitors or MEMS varactors placed on the resonator lines of each filter. Since the tunable dielectric capacitors show high Q, high IP3 (low inter-modulation distortion) and low cost, the tunable filter in the present invention has the advantage of low insertion loss, fast tuning speed, and high power handling.

A combination of such tunable filters with a software-controlled switching system, that is a tunable filter bank, may cover an even wider range of frequency selection in complex radio systems. To switch the frequency band in a tunable filter bank, two mechanisms may be generally available to achieve this function: one is to direct signals between individual tunable filters by switches and another is to switch inside a tunable filter to change the filter frequency band. The latter is employed in one embodiment of the present invention to vary the resonator length by switching “ON” or “OFF” the PIN diodes which are connected to the resonators, and thus shift the filter passband.

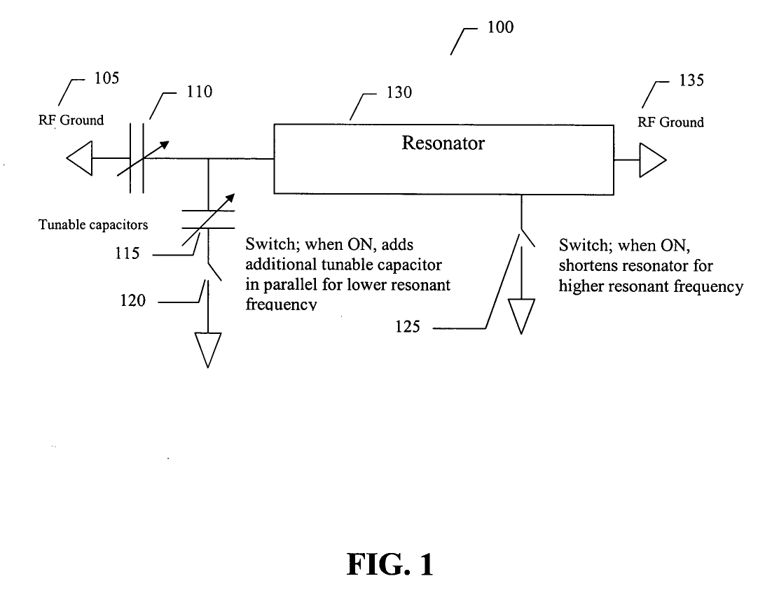

Turning now the figures, in FIG. 1 is a tunable filter 100 that can be used in a tunable filter bank of the present invention. The tunable filter 100 may have resonator 130 with tunable capacitors 110 and 115 between the resonator 100 and RF ground 105. If switch 120 is closed, it effectively adds an additional tunable capacitor in parallel for lower resonant frequency. When a second switch 125 is closed, it effectively shortens the resonator for higher resonant frequency. RF ground is provided at 135.

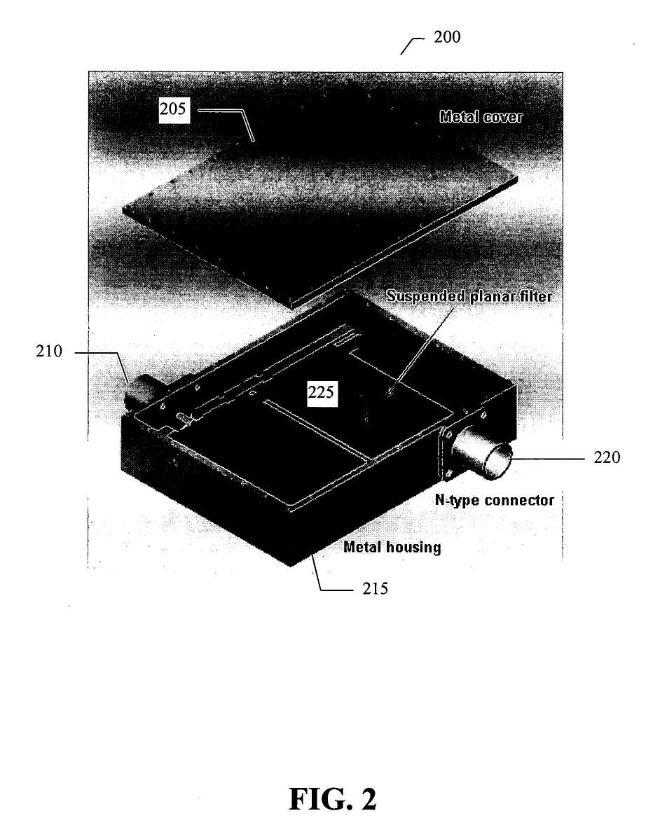

Turning now to FIG. 2, shown generally at 200, is an Illustration of the assembly of a two-pole switched-resonator filter bank according to one embodiment of the present invention with an assembly of a two-pole switched-resonator filter bank in suspended stripline 225 form enclosed in a metal housing 215 and metal housing cover 205 with N-type connectors for RF input 210 and output 220. The resonators in this switchable configuration are combline-type resonators with the center frequency determined by the resonator electrical length and the associated capacitance value. Varying the resonator length or the capacitance value changes the resonant frequency and thus the center frequency of filter passband.

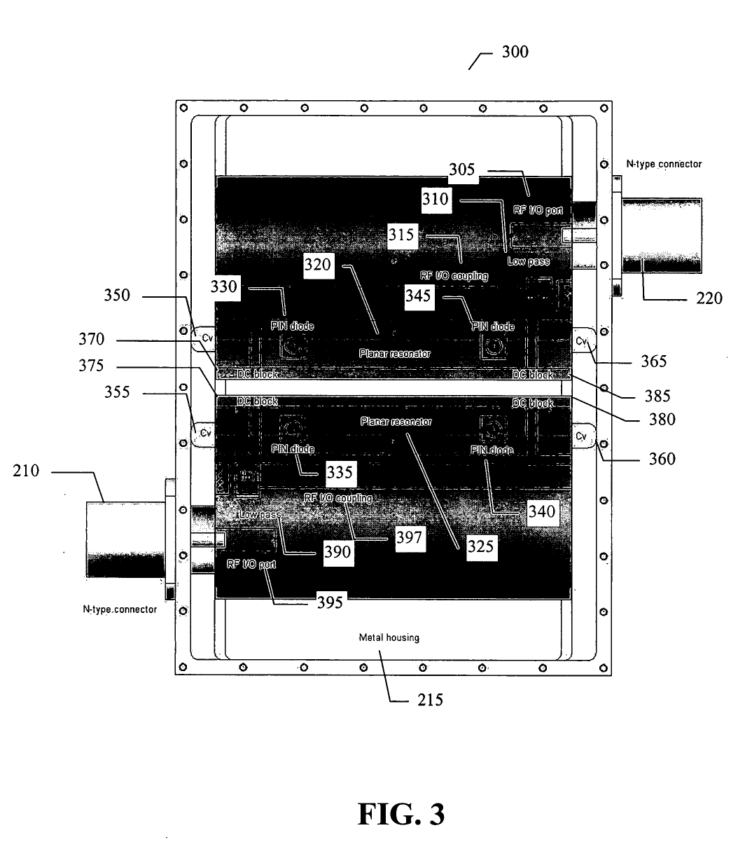

Turning now to FIG. 3 is a filter bank 300 consisting of: two or more resonators 320 and 325 forming filter multi-poles with switchable resonator length controlled by the PIN diodes 330, 335, 340 and 346; RF I/O proximity coupling transmission lines 315 and 397 via RF I/O ports 305 and 395 and N-type connectors 210 and 220; and low-pass section 310 and 390 to remove spurious high frequency modes. The resonators 320 and 325 and I/O coupling 315 and 397 are implemented in suspended stripline form. Although two resonators are used in this embodiment of the present invention, it should be understood than any number of resonators can be used and are anticipated by the present invention. The number of filter poles depends on the requirements of filter performance and is not limited to the number of poles depicted in this embodiment of the present invention. The primary tuning elements are voltage-controlled tunable dielectric capacitors 350, 355, 360 and 365 placed on the resonator lines of each filter. Variations of the capacitance of the tunable capacitor due to applied bias voltage affect the distribution of the electric field in the filter, which in turn varies the resonant frequency. DC blocks are shown at 370, 375, 380 and 385. The PIN diodes 330, 335, 340 and 346, which are connected to the resonators, may be switched “ON” or “OFF” to vary the resonator length and thus step-change the filter passband as well.

A balanced resonator structure may be implemented by involving two tunable dielectric capacitors per resonator. With the RF voltage applied in opposite phase over the two tunable dielectric capacitors, inter-modulation products generated in each tunable dielectric capacitor will tend to cancel, to the extent that perfect circuit symmetry can be obtained. A further advantage of having two tunable dielectric capacitors per resonator is that power dissipation is shared between them. However, it is understood that the present invention is not limited to two tunable dielectric capacitors.

In another embodiment of the present invention, as a further enhancement, tuning range can be extended by switching additional tunable capacitors in series or parallel with the tunable capacitors. Further, PIN diodes or MEMS switches can be used as switch elements.

For the purpose of filtering high-power RF signals, a filter should be capable of withstanding high RF instant voltage and heat dissipation. As the present invention may be a tunable filter bank made in PCB-based planar suspended stripline structure, it may be capable of handling RF applications up to medium power level. Although the present invention is not limited in this respect.

The two-pole PCB-structured switchable filter bank in one embodiment of the present invention FIG. 2 may also be represented by an equivalent circuit as shown in FIG. 3. Although it is understood that this is but one of numerous circuits that can be utilized in the present invention. In this exemplary circuit, four shunted-circuit parts connected to the filter's two-pole resonators are the equivalent circuits of high-power PIN diodes 410, 415, 420 and 425. These PIN diodes step-change the resonator length and thus the resonant frequency. For continuous frequency tuning, the varactors (i.e. Cv's) 440, 445, 450 and 455 in the resonant structures are incorporated to make the frequency band tunable. The low-pass section 430 and 435 consisting of L (inductor) and C (capacitor) is inserted between the input/output port and the RF I/O coupling portion.

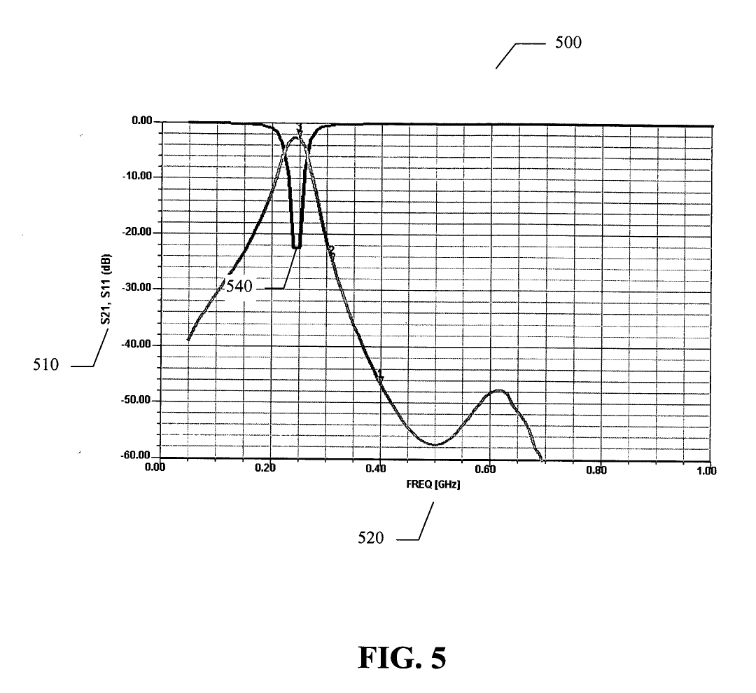

Turning now to FIG. 5 is a diagram 500 in dB 510 vs. Frequency 520 showing the filter response with center frequency of 225 MHz 540 when PIN diodes are switched “OFF” and varactors at zero bias.

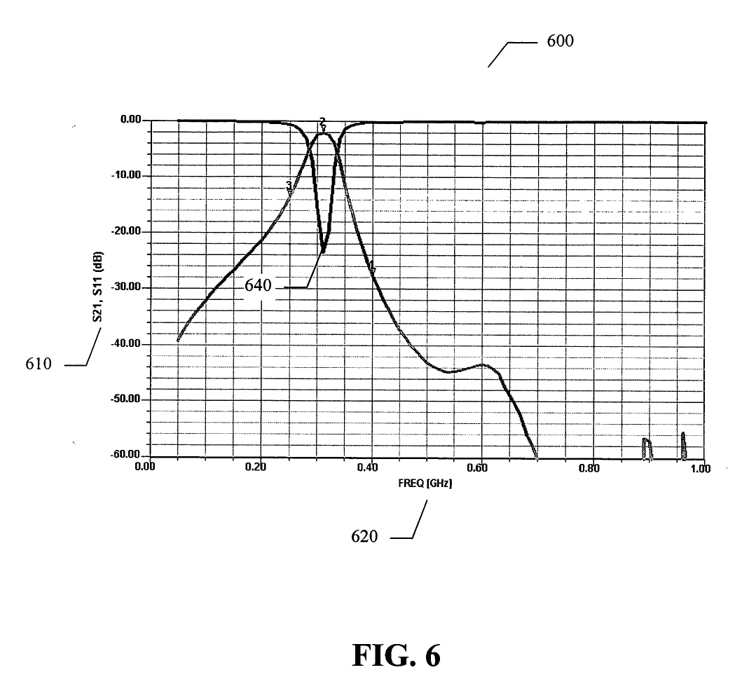

FIG. 6 is a diagram 600 in dB 610 vs. Frequency 620 which illustrates the filter response with center frequency of 310 MHz 640 when PIN diodes remain “OFF” and varactors at a high DC bias.

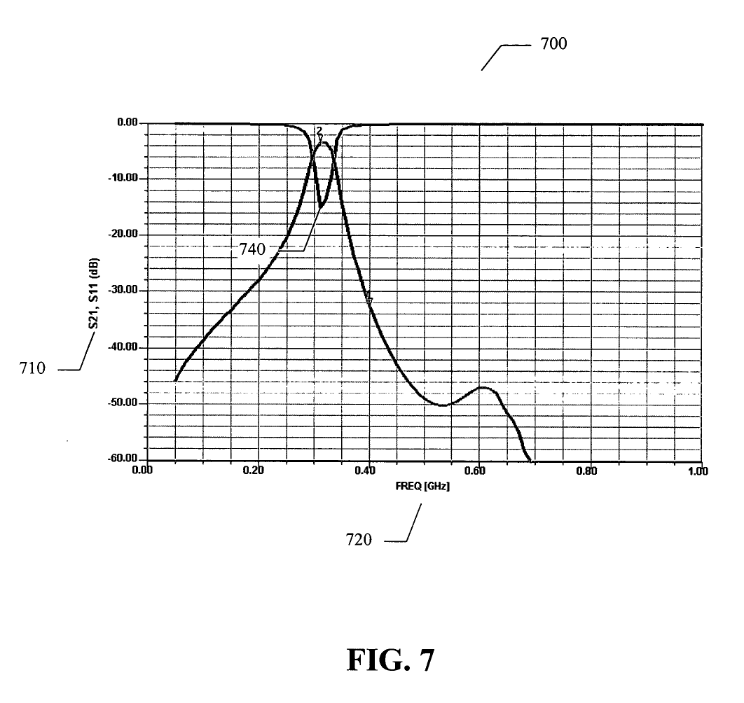

FIG. 7 is a diagram 700 in dB 710 vs. Frequency 720 that shows the filter response with center frequency of 310 MHz 740 when PIN diodes switched “ON” to shorten the resonator length and varactors at zero bias.

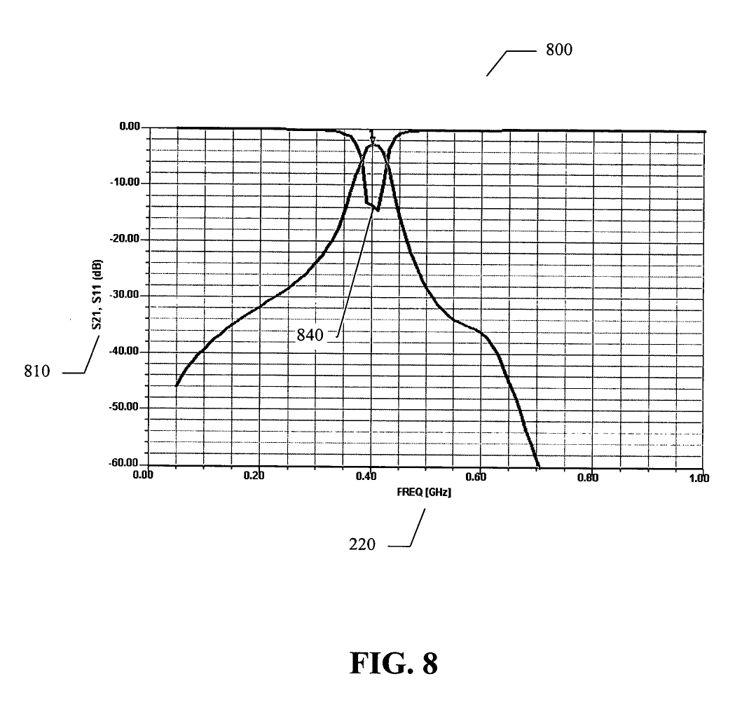

FIG. 8 is a diagram 800 in dB 810 vs. Frequency 820 shows the filter response with center frequency of 400 MHz 840 when PIN diodes stay “ON” to ground a portion of the resonator and varactors at a high DC bias. Thus this tunable filter bank can continuously cover a frequency application range from 225 MHz to 400 MHz by using PIN diode switching and Parascan® varactors technology.

While various embodiments of the present invention have been described above, it should be understood that they have been presented by way of example, and not limitation. It will be apparent to persons skilled in the relevant art that various changes in form and detail can be made therein without departing from the spirit and scope of the invention.

The present invention has been described above with the aid of functional building blocks illustrating the performance of specified functions and relationships thereof. The boundaries of these functional building blocks have been arbitrarily defined herein for the convenience of the description. Alternate boundaries can be defined so long as the specified functions and relationships thereof are appropriately performed. Any such alternate boundaries are thus within the scope and spirit of the claimed invention. Thus, the breadth and scope of the present invention should not be limited by any of the above-described exemplary embodiments, but should be defined only in accordance with the following claims and their equivalents.

All cited patent documents and publications in the above description are incorporated herein by reference.

1. A voltage-controlled tunable filter, comprising:
a first resonator, said first resonator including at least one tunable capacitor and at least one PIN diode; and
a second resonator coupled to said first resonator, said second resonator including at least one tunable capacitor and at least one PIN diode.

2. The voltage-controlled tunable filter of claim 1, further comprising a low-pass section between a coupling line coupling said first and said second resonator and an input port.

3. The voltage-controlled tunable filter of claim 1, wherein said first resonator is coupled to said second resonator through proximity coupling.

4. The voltage-controlled tunable filter of claim 1, wherein said at least one PIN diode in said first resonator is two PIN diodes and said at least one tunable capacitor in said first resonator is two tunable capacitors.

5. The voltage-controlled tunable filter of claim 1, wherein said at least one PIN diode in said second resonator is two PIN diodes and said at least one tunable capacitor in said second resonator is two tunable capacitors.

6. The voltage-controlled tunable filter of claim 1, further comprising at least one DC blocking capacitor in said first resonator and at least one DC blocking in said second resonator.

7. The voltage-controlled tunable filter of claim 6, wherein said at least one DC blocking capacitor in said first resonator is two DC blocking capacitors and said at least one DC blocking in said second resonator is two DC blocking capacitor.

8. The voltage-controlled tunable filter of claim 1, further comprising an input transmission line coupled said first resonator.

9. The voltage-controlled tunable filter of claim 1, further comprising an output transmission line coupled to said second resonator.

10. The voltage-controlled tunable filter of claim 1, further comprising switching additional tunable capacitors in series or parallel with said at least one tunable capacitor in said first or said second resonator.

11. The voltage-controlled tunable filter of claim 1, further comprising at least one DC biasing line associated with said at least one tunable capacitor included within said first resonator, and at least one DC biasing line associated with said at least one tunable capacitor included within said second resonator.

12. The voltage-controlled tunable filter of claim 1, further comprising at least one resister in said at least one DC biasing line associated with said at least one tunable capacitor included within said first resonator; or at least one resister in said at least one DC biasing line associated with said at least one tunable capacitor included within said second resonator.

13. The voltage-controlled tunable filter of claim 2, wherein said low-pass section comprises a series inductor between two shunt capacitors forming a “π” section.

14. The voltage-controlled tunable filter of claim 1, wherein said at least one tunable capacitor included within said first resonator is a tunable dielectric capacitor; and/or said at least one tunable capacitor included within said second resonator is a tunable dielectric capacitor.

15. The voltage-controlled tunable filter of claim 14, wherein said at said at least one tunable dielectric capacitor included within said first resonator comprises a low loss tunable dielectric material and has metallic electrodes with predetermined shape, size, and distance; and/or said at least one tunable dielectric capacitor included within said second resonator comprises a low loss tunable dielectric material and has metallic electrodes with predetermined shape, size, and distance.

16. The voltage-controlled tunable filter of claim 1, wherein said at said at least one tunable capacitor included within said first or said second resonator is at least one MEMS tunable capacitors.

17. The voltage-controlled tunable filter of claim 16, wherein said at least one MEM tunable capacitor utilizes a parallel plate topology.

18. The voltage-controlled tunable filter of claim 16, wherein said MEMS tunable capacitor utilizes an interdigital topology.

19. The voltage-controlled tunable filter of claim 1, further comprising at least one additional resonator, said at least one additional resonator coupled to said first or said second resonator.

20. The voltage-controlled tunable filter of claim 1, wherein said at said at least one tunable capacitor included within said first or said second resonator is at least one semiconductor tunable capacitor.

21. The voltage-controlled tunable filter of claim 1, wherein the center frequency of said tunable filter is tuned by changing the capacitance of said tunable capacitor by changing the bias voltage.

22. The voltage-controlled tunable filter of claim 1, wherein the center frequency of said filter is step-changed by switching said at least one PIN diode to vary the resonator length.

23. A method of tuning a filter by applying a voltage, comprising:
varying the capacitance of a tunable capacitor by applying a voltage, said tunable capacitor included in a first resonator, said first resonator further including at least one PIN diode; and
varying the capacitance of a tunable capacitor by applying a voltage, said tunable capacitor included in a second resonator, said second resonator further including at least one PIN diode and is coupled to said first resonator.

24. The method of claim 1, further comprising step-changing the center frequency of said filter by switching said PIN diodes to vary the resonator length of said first and/or said second resonators.

25. The method of claim 24, further comprising coupling a low-pass section between a coupling line coupling said first and said second resonator and an input port.

26. The method of claim 25, wherein said first resonator is coupled to said second resonator through proximity coupling.
